(19) United States
(12) Patent Application Publication
(10) Pub. No.: US 2012/0180204 A1
(43) Pub. Date: Jul. 19, 2012

(54) GRADIENT TINTED SHIELD

(76) Inventor: Victor J. Hawkins, Castle Rock, CO (US)

(21) Appl. No.: 13/350,506

(22) Filed: Jan. 13, 2012

Related U.S. Application Data
(60) Provisional application No. 61/432,389, filed on Jan. 13, 2011.

(51) Int. Cl. A42B 3/22; G02C 7/10; G02B 5/22

(52) U.S. Cl. 2/424; 359/888; 351/159.64; 351/159.73

(57) ABSTRACT

A gradient tinted shield may include one or more areas of gradient opacity, varying vertically from a user's eyeline. In one implementation, two areas of gradient opacity are located on the gradient tinted shield, one above the user's eyeline and one below the user's eyeline. Further, an area of constant opacity may be located at the user's eyeline.

### CROSS-REFERENCE TO RELATED APPLICATIONS

The present application claims benefit of priority to U.S. Provisional Patent Application No. 61/432,389, entitled “Tinted Shield,” and filed on Jan. 13, 2011, which is specifically incorporated by reference herein for all that it discloses or teaches.

### BACKGROUND

Headgear, such as visors, goggles, and other eye and face shields, are used to protect the wearer's eyes and/or face from wind, debris, and other hazards. Many versions of such headgear have shields that are either completely transparent or completely tinted.

### SUMMARY

Implementations described and claimed herein address the foregoing problems by providing user face and eye shields with one or more gradient tinted areas that provides the user's eyes and/or face with light intensity protection that is effective in varying lighting conditions.

Other implementations are also described and recited herein.

### BRIEF DESCRIPTIONS OF THE DRAWINGS

FIG. 1 is a perspective view of an example American football helmet incorporating a gradient shield having an upper gradient tinted region and a lower gradient tinted region.

FIG. 2 is a perspective view of an example gradient shield having an upper gradient tinted region.

FIG. 3 is a perspective view of an example gradient shield having a lower gradient tinted region.

FIG. 4 is a perspective view of an example gradient shield having an upper gradient graphic and a removable lower gradient tinted region.

FIG. 5A is a sectional side view of an example American football helmet incorporating a gradient shield having an upper gradient tinted region.

FIG. 5B is a sectional side view of an example American football helmet incorporating a gradient shield having an upper gradient tinted region and a lower gradient tinted region.

FIG. 6 is a perspective view of an example motorcycle helmet incorporating a gradient shield having an upper gradient tinted region and a lower gradient tinted region.

FIG. 7 is a perspective view of an example hockey helmet incorporating a gradient shield having an upper gradient tinted region.

FIG. 8 is a perspective view of an example hockey goalie helmet incorporating a gradient shield having an upper gradient tinted region and a lower gradient tinted region.

FIG. 9 is a perspective view of an example baseball catcher's helmet incorporating a gradient shield having an upper gradient tinted region and a lower gradient tinted region.

FIG. 10 illustrates operations for making a gradient shield according to the presently disclosed technology.

### DETAILED DESCRIPTIONS

Example implementations of headgear and/or face shields according to the presently disclosed technology are disclosed herein. Headgear as referred to herein includes helmets, visors, face shields, goggles, glasses, and other eye and/or face protection gear. The headgear referred to herein incorporates one or more gradient shields to protect a user's eyes, face, and/or head. The gradient shields may include one or more lenses, visors, masks, or other eye and/or face protection gear.

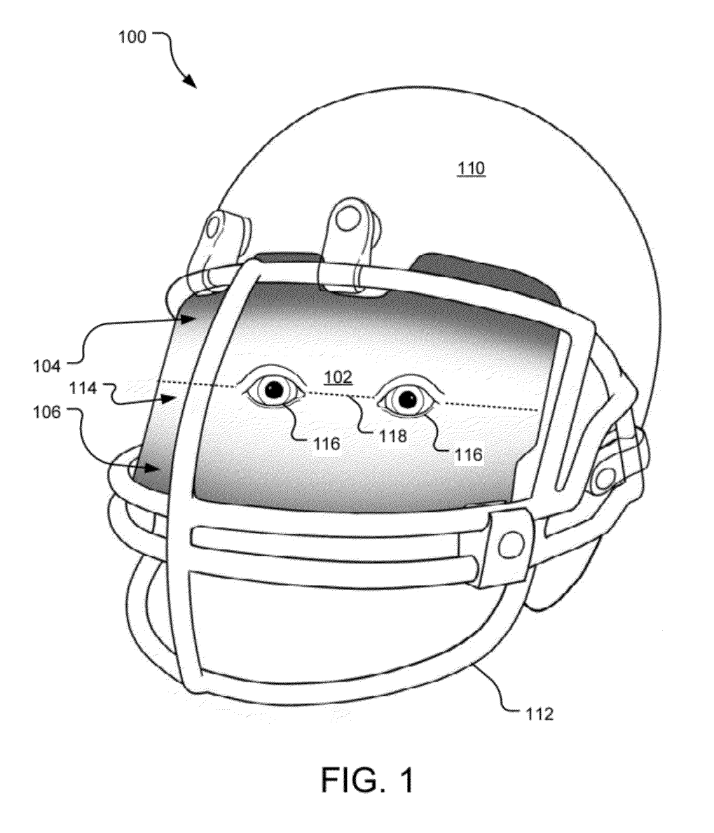

FIG. 1 is a perspective view of an example American football helmet 100 incorporating a gradient shield 102 having an upper gradient tinted region 104 and a lower gradient tinted region 106. The helmet 100 may be used to protect a user (whose eyes 116 are visible through the gradient shield 102) from injury while participating in a game of American football. Further, the helmet 100 may be used to protect the user from injury while participating in other activities (e.g., baseball, hockey, rugby, lacrosse, motorcycling, etc.). The helmet 100 incorporates a hard and/or soft shell section 110 that at least partially encompasses and protects the user's head and/or face from damage from potential impacts that may occur during use of the helmet 100. Further, the shell section 110 may be transparent, semi-transparent, or opaque. The helmet 100 further incorporates a face cage 112 to protect the user's face, particularly the user's eyes 116 from high-energy impacts. In other implementations, the helmet 100 does not include a face cage 112 or includes a chin guard (not shown).

The gradient shield 102 is attached to one or both of the shell section 110 and the face cage 112 at attachment points (not shown) and protects the user's face and eyes 116 from impacts that may penetrate through the individual bars of the face cage 112. In implementations that do not include the face cage 112 and/or the chin guard, the gradient shield 102 provides most, if not all protection, of the user's face, particularly in the extra-sensitive area of the user's eyes 116. The gradient shield 102 is uniformly transparent or semi-transparent in a middle region 114 aligned with the user's eyeline 118, or vertical level of the user's eyes 116, so that the user may see out of the helmet 100 and/or other individuals may see the user's face and/or eyes within the helmet 100.

The gradient regions 104, 106 vary in opacity from top to bottom. More specifically, the gradient shield 102 has a maximum opacity at each of the top and bottom of the gradient shield 102 that uniformly decreases within the gradient regions 104, 106 toward the eyeline 118. The middle region 114 has a constant or uniform opacity. As a result, the amount of light transmitted through the gradient shield 102, specifically from the exterior of the gradient shield 102 to the interior of the gradient shield 102 and impinging on the user's face and eyes 116 varies according to the positions of one or more exterior light sources (not shown) with respect to the location of the gradient shield 102 and the angle at which the light enters the gradient shield 102. Further, the gradient regions 104, 106 and the middle region 114 may have a colored tint. Still further, a color tint on the regions 104, 106 may vary in color from top to bottom.

One or both of the gradient regions 104, 106 may be removably attached to the gradient shield 102 or non-removably integrated into the gradient shield 102, for example. Other implementations with one or more differently located gradient opacity regions on the gradient shield 102 are contemplated herein.

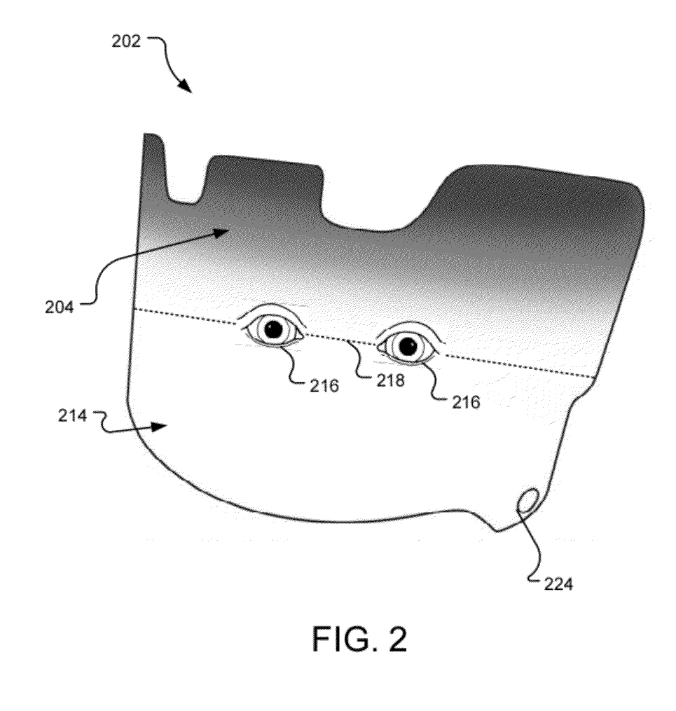

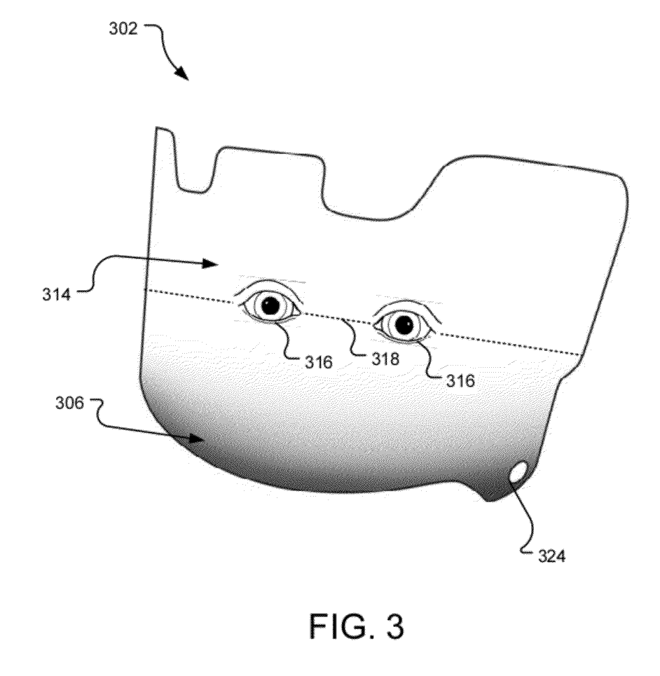

While the helmet 100 comprises gradient shield 102 with upper and lower tinted regions 104, 106 and a middle clear region 114, other implementations are contemplated. For example, the gradient shield 102 may include just the upper tinted region 104 (see e.g., gradient shield 202 of FIG. 2) or just the lower tinted region 106 (see e.g., gradient shield 302 of FIG. 3), with the remainder of the gradient shield 102 having uniform light transmission properties. In another example, there may be no middle clear region 114, with the upper and lower tinted regions 104, 106 merging into one another at the middle of the gradient shield 102. In yet another implementation, the middle region 114 may be uniformly tinted to mute light entering the helmet 100 along the user's eye line with the tinting increasing with vertical distance from the user's eye line.

In still another implementation, the upper and lower tinted regions 104, 106 of the gradient shield 102 may have a uniform transparency to allow for clear, unobstructed viewing or to allow maximum light to penetrate the gradient shield 102 in upward and downward directions away from the gradient shield 102. The middle region 114 may have a gradient tint in the wearer's line of view with a maximum opacity in the user's eyeline 118. As a result, the user may see through the gradient shield 102, but the user's eyes would be substantially protected from a light source directly in front of the user. For example, a welding mask with a gradient tinted region 114 in the user's line of view would protect the user's eyes from bright light emanating from a welding point without significantly obscuring the user's overall vision while welding. In other implementations, the gradient regions 104, 106 may vary in opacity from side to side.

FIG. 2 is a perspective view of an example gradient shield 202 having an upper gradient tinted region 204. The gradient shield 202 is made of safety glass (e.g., tempered glass, wired glass, or laminated glass) or a transparent plastic (e.g., polycarbonate or cellulose acetate), for example, with an opacity that may be varied over the surface of the gradient shield 202. The opacity may be varied by applying a translucent film onto or embedded within the gradient shield 202 and/or incorporating opaque powdered or granular materials into the gradient shield 202 material as the gradient shield 202 is manufactured. The gradient shield 202 may be attached to a helmet (not shown) via one or more attachment points (e.g., attachment point 224). For example, there may be an attachment point on each side of the gradient shield 202. Further, there may be one or more attachment points on the top and/or bottom of the gradient shield 202.

The light transmittance of the gradient shield 202 may vary from near 0% to near 100%, depending upon location on the gradient shield 202. For example, the transmittance within lower region 214 is constant at greater than 80% and the transmittance within the gradient tinted region 204 varies from 80% to 5% with increasing vertical distance from the user's eyeline 218. The transmittance may vary linearly, logarithmically, or according to any other function with distance from the eyeline 218, for example. In some implementations, the level of opacity within various regions of the gradient shield 202 may user-selectable and varied between two or more settings (e.g., via electromagnetic devices, suspended particle devices, polymer dispersed liquid crystal devices, and/or micro-blinds incorporated within the gradient shield 202).

A lower region 214 of the gradient shield 202 has a constant low opacity that provides a user (whose eyes 216 are visible through the gradient shield 102) a clear, unobstructed view outward and also provides eye and face protection for the user. The gradient tinted region 204 utilizes gradient shading to transition from darker opacity at the top of the gradient shield 202 to lighter opacity in the lower region 214, which is aligned with the user's eyeline 218. In one implementation, the user can see through the gradient tinted region 204, but the dark opacity within the gradient tinted region 204 protects the user's eyes 216 from bright light emitted from above the gradient shield 202. Because the gradient tinted region 204 protects the user's eyes 216 from bright lights and allows for a clear, unobstructed view, the gradient shield 202 provides the user both impact and light protection in various lighting conditions (e.g., daylight, dusk, nighttime, dawn, and various indoor lighting conditions).

For example, many sporting venues utilize bright overhead lights for events that take place at night or in dark conditions. The upper tinted region 204 of the gradient shield 202 mutes the intensity of the light emitted from the overhead lights entering the gradient shield 202, while offering clear, unmuted vision forward out of the gradient shield 202 via the lower region 214. Additionally, many sports require the user's eyeline 218 to be unobstructed so others, such as officials and medical personnel, can see the user's eyes 216 in the event of injury. The gradient shield 202 allows clear, unmuted vision into the gradient shield 202 via the lower region 214. In other implementations, the tinted region 204 provides one-way visibility. More specifically, the user can see out of the gradient shield 202 through the tinted region 204 but others cannot see into the gradient shield 202 through the tinted region 204.

FIG. 3 is a perspective view of an example gradient shield having a lower gradient tinted region 306. The gradient shield 302 is made of safety glass or a transparent plastic, for example, with an opacity that may be varied over the surface of the gradient shield 302. The opacity may be varied by applying a translucent film onto or embedded within the gradient shield 302 and/or incorporating opaque powdered or granular materials into the gradient shield 302 material as the gradient shield 302 is manufactured. The light transmittance of the gradient shield 302 may vary from near 0% to near 100%, depending upon location on the gradient shield 302. In some implementations, the level of opacity within various regions of the gradient shield 302 may user-selectable and varied between two or more settings. The gradient shield 302 may be attached to a helmet (not shown) via one or more attachment points (e.g., attachment point 324). For example, there may be an attachment point on each side of the gradient shield 302. Further, there may be one or more attachment points on the top and/or bottom of the gradient shield 302.

An upper region 314 of the gradient shield 302 has a constant low opacity that provides a user (whose eyes 316 are visible through the gradient shield 102) a clear, unobstructed view outward and also provides eye and face protection for the user. The gradient tinted region 306 utilizes gradient shading to transition from darker opacity at the bottom of the gradient shield 302 to lighter opacity in the upper region 314, which is aligned with the user's eyeline 318. In one implementation, the user can see through the gradient tinted region 306, but the dark opacity within the gradient tinted region 306 protects the user's eyes 316 from bright light emitted from below the helmet 300. Because the gradient tinted region 306 protects the user's eyes 316 from bright lights and allows for a clear, unobstructed view, the gradient shield 302 provides the user both impact and light protection in various lighting conditions (e.g., daylight, dusk, nighttime, dawn, and various indoor lighting conditions).

For example, many sporting venues are outdoors in locations with a variety of seasonal conditions. The lower tinted region 306 of the gradient shield 302 mutes the intensity of light reflecting off the ground (e.g., on a snow-covered field) or that is otherwise emitted from below the user's eyeline 318, while offering clear, unmuted vision forward out of the gradient shield 302 via the upper region 314. Additionally, many sports require the user's eyes 316 to be unobstructed so others, such as officials and medical personnel, can see the user's eyes 316 in the event of injury. The gradient shield 302 allows clear, unmuted vision into the gradient shield 302 via the upper region 314. In other implementations, the tinted region 204 provides one-way visibility. More specifically, the user can see out of the gradient shield 302 through the tinted region 306 but others cannot see into the gradient shield 302 through the tinted region 306.

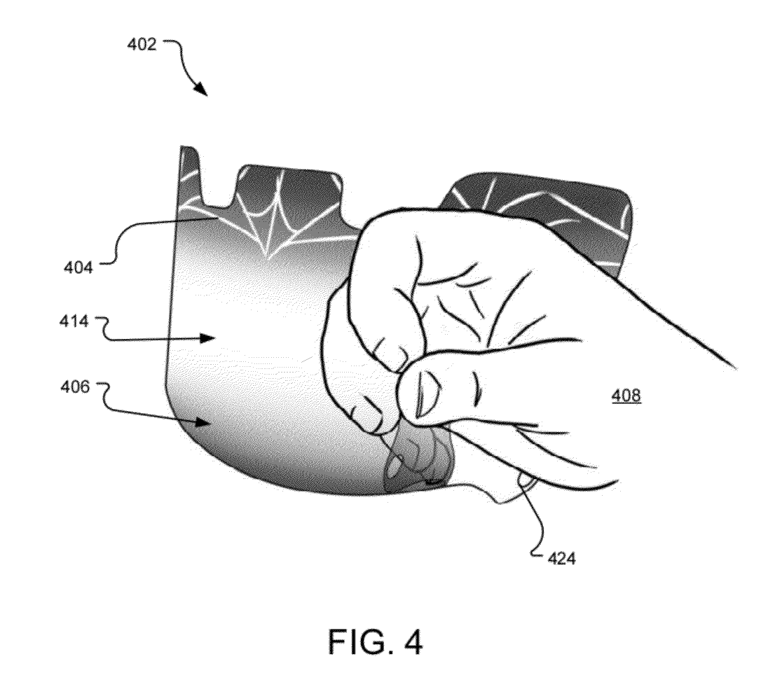

FIG. 4 is a perspective view of an example gradient shield 402 having an upper gradient graphic 404 and a removable lower gradient tinted decal 406. The upper gradient graphic 404 decreases in opacity from top to bottom and incorporates a spider web visual feature. Other visual features are contemplated herein (e.g., flames). Other implementations include graphics or designs to match a team colors or a mascot. This may help identify the user of the gradient shield 402 as a member of a particular team to opposing players, fans, and officials. This may further be useful to intimidate an opposing team or competitors by utilizing intimidating graphics or designs. In various implementations, the graphic 404 is integrated into the gradient shield 402; or drawn, etched, or otherwise put directly onto the gradient shield 402. The gradient shield 402 may be attached to a helmet (not shown) via one or more attachment points (e.g., attachment point 424). For example, there may be an attachment point on each side of the gradient shield 402. Further, there may be one or more attachment points on the top and/or bottom of the gradient shield 402.

The lower gradient tinted decal 406 decreases in opacity from bottom to top and is removable by a user (e.g., via peeling with the user's hand 408). More specifically, a user may grasp a corner or edge of the decal 406 and pull the decal 406 from the gradient shield 402. The decal 406 may be affixed to any portion of the gradient shield 402 that the user desires. Thus, the user may move the decal 406 depending on the relative position of a light source the user views from behind the gradient shield 402. The decal 406 may be a sticker, for example. Further, the decal 406 may be reusable, allowing multiple decals to be exchanged on the gradient shield 402 depending on the needs and desires of the user. Still further, the user may remove decal 406 entirely. The decal 406 may comprise various colors, designs, and/or graphics.

In various implementations, the decal 406 is affixed to the gradient shield 402 electrostatically or via an adhesive. The decal 406 may also snap, slide, rotate, or otherwise move into place on the gradient shield 402. Additionally, the decal 406 may include a material of varying translucency or a uniformly opaque material having a series of micro-holes that allow the user to see through the decal 406. Varying the size and/or spacing of the micro-holes will vary the apparent opacity of the opaque material. The decal 406 may also be photochromic (e.g., the decal's opacity changes with exposure to light). Other materials with a varying opacity are contemplated to construct the decal 406. Further, the upper gradient graphic 404 may include one or more characteristics of the decal 406 and/or the decal 406 may include one or more characteristics of the gradient graphic 404.

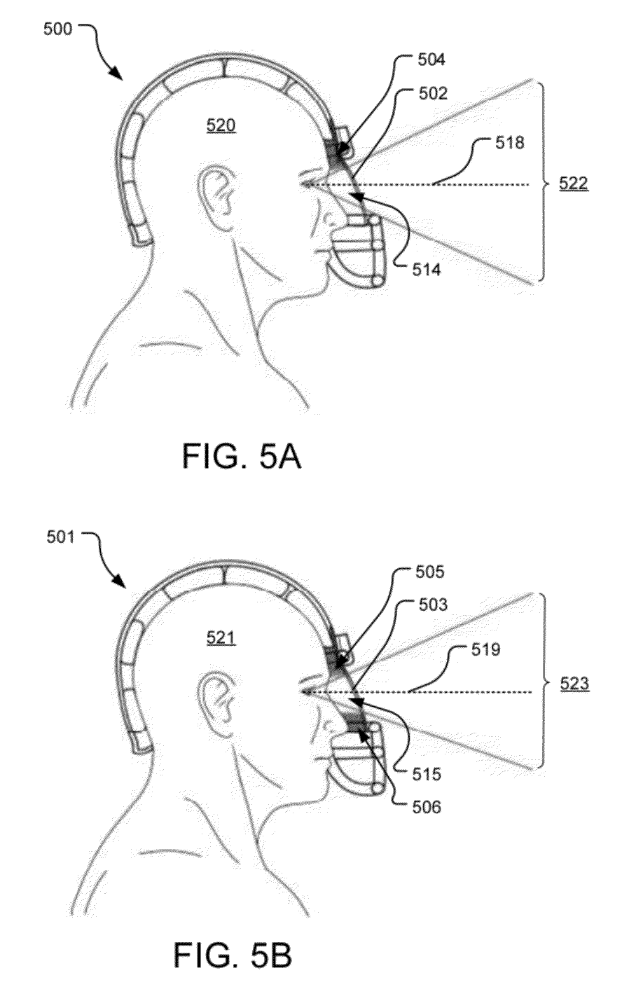

FIG. 5A is a sectional side view of an example American football helmet 500 incorporating a gradient shield 502 having an upper gradient tinted region 504. The helmet 500 may be used to protect a user 520 from injury while participating in a game of American football or other activities. The gradient shield 502 protects the user's face and eyes from impacts and intense light. The gradient shield 502 is uniformly transparent or semi-transparent in a lower region 514 aligned with the user's eyeline 518 so that the user 520 may see out of the helmet 500 within an unobstructed viewing range 522 and/or other individuals may see the user's face and/or eyes within the helmet 500.

FIG. 5B is a sectional side view of an example American football helmet 501 incorporating a gradient shield 503 having an upper gradient tinted region 505 and a lower gradient tinted region 506. The helmet 501 may be used to protect a user 521 from injury while participating in a game of American football or other activities. The gradient shield 503 protects the user's face and eyes from impacts and intense light. The gradient shield 503 is uniformly transparent or semi-transparent in a middle region 515 aligned with the user's eyeline 519 so that the user 521 may see out of the helmet 501 within an unobstructed viewing range 523 and/or other individuals may see the user's face and/or eyes within the helmet 501. The unobstructed viewing range 523 of FIG. 5B is smaller than the unobstructed viewing range 522 of FIG. 5A because the lower part of the unobstructed viewing range 522 of FIG. 5A is blocked by the lower gradient tinted region 506, which does not exist on gradient shield 502 of FIG. 5A.

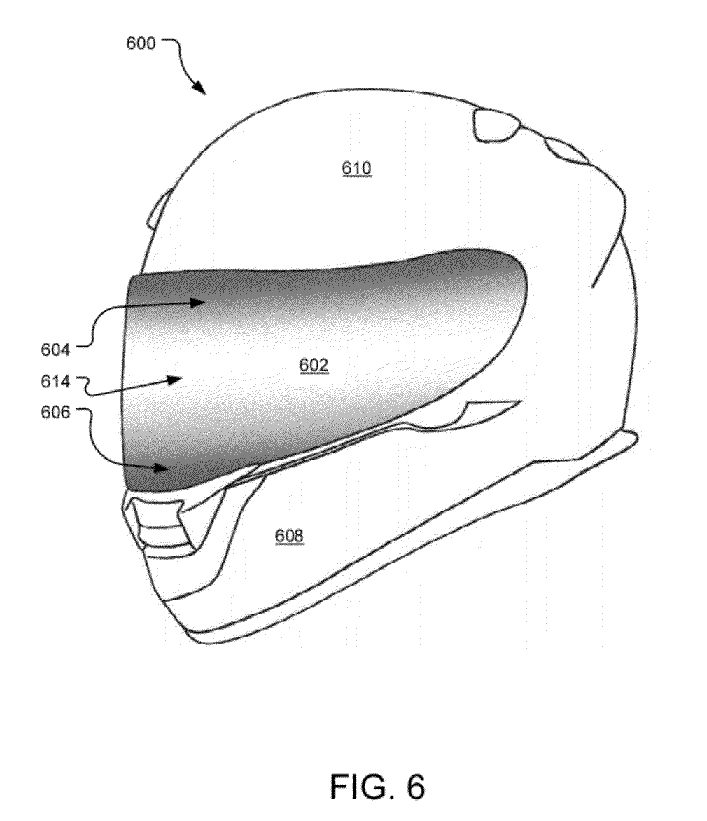

FIG. 6 is a perspective view of an example motorcycle helmet 600 incorporating a gradient shield 602 having an upper gradient tinted region 604 and a lower gradient tinted region 606. The helmet 600 may be used to protect a user (not shown) from injury while riding a motorcycle, or while participating in other activities. The helmet 100 incorporates a hard and/or soft shell section 610 that protects the user's skull and/or face from damage from potential impacts that may occur during use of the helmet 600. Further, the shell section 610 may be transparent, semi-transparent, or opaque. The helmet 600 further incorporates a chin guard 608 to protect the user's chin from high-energy impacts. In other implementations, the helmet 600 does not include the chin guard 608.

The gradient shield 602 protects the user's face from potential impacts, particularly in the extra-sensitive area of the user's eyes. The gradient shield 602 is at least semi-transparent in a middle region 614 aligned with the user's eyes so that the user may see out of the helmet 600 and/or other individuals may see the user's face and/or eyes within the helmet 600.

The gradient regions 604, 606 vary in opacity from top to bottom. More specifically, the gradient shield 602 has a maximum opacity at the top and bottom of the gradient shield 602 that uniformly decreases within each of the gradient regions 604, 606 toward the middle of the gradient shield 602. The middle region 614 has a constant opacity. As a result, the amount of light transmitted through the gradient shield 602, specifically from the exterior of the gradient shield 602 to the interior of the gradient shield 602 and impinging on the user's face varies according to the positions of one or more exterior light sources (not shown) with respect to the location of the gradient shield 602 and the angle at which the light emanating from the light source(s) enters the gradient shield 602.

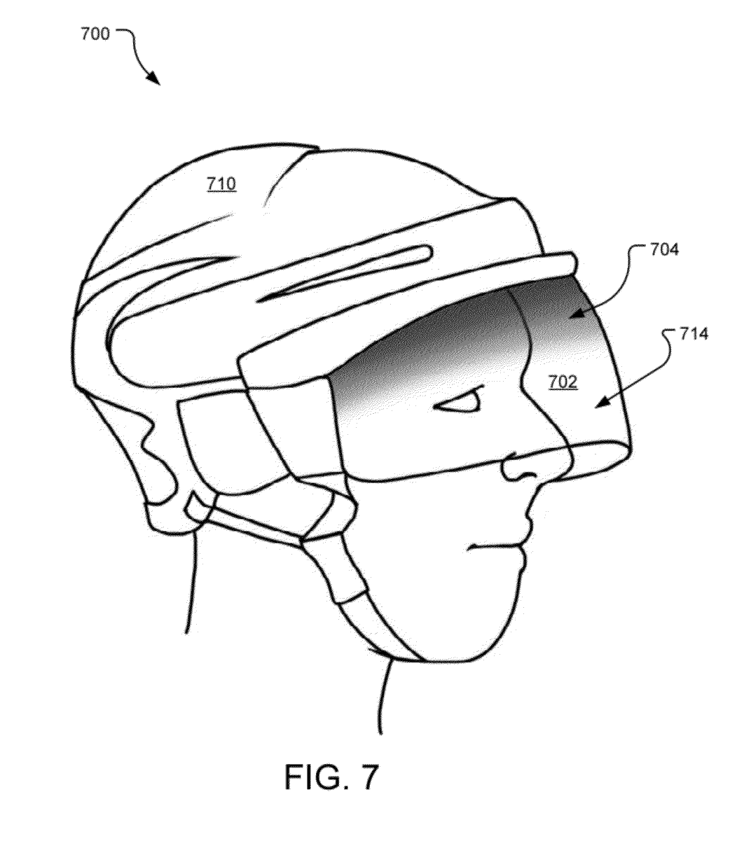

FIG. 7 is a perspective view of an example hockey helmet 700 incorporating a gradient shield 702 having an upper gradient tinted region 704. The helmet 700 may be used to protect a user (not shown) from injury while participating in a game of hockey, or while participating in other activities. The helmet 700 incorporates a hard and/or soft shell section 710 that protects the user's skull and/or face from damage from potential impacts that may occur during use of the helmet 700. Further, the shell section 710 may be transparent, semi-transparent, or opaque.

The gradient shield 702 protects the user's face from potential impacts, particularly in the extra-sensitive area of the user's eyes. The gradient shield 702 is at least semi-transparent in a lower region 714 aligned with the user's eyes so that the user may see out of the helmet 700 and/or other individuals may see the user's face and/or eyes within the helmet 700.

The gradient region 704 varies in opacity from top to bottom. More specifically, the gradient shield 702 has a maximum opacity at the top of the gradient shield 702 that uniformly decreases within the gradient region 704 toward the middle of the gradient shield 702. The lower region 714 has a constant opacity. As a result, the amount of light transmitted through the gradient shield 702, specifically from the exterior of the gradient shield 702 to the interior of the gradient shield 702 and impinging on the user's face varies according to the positions of one or more exterior light sources (not shown) with respect to the location of the gradient shield 702 and the angle at which the light emanating from the light source(s) enters the gradient shield 702.

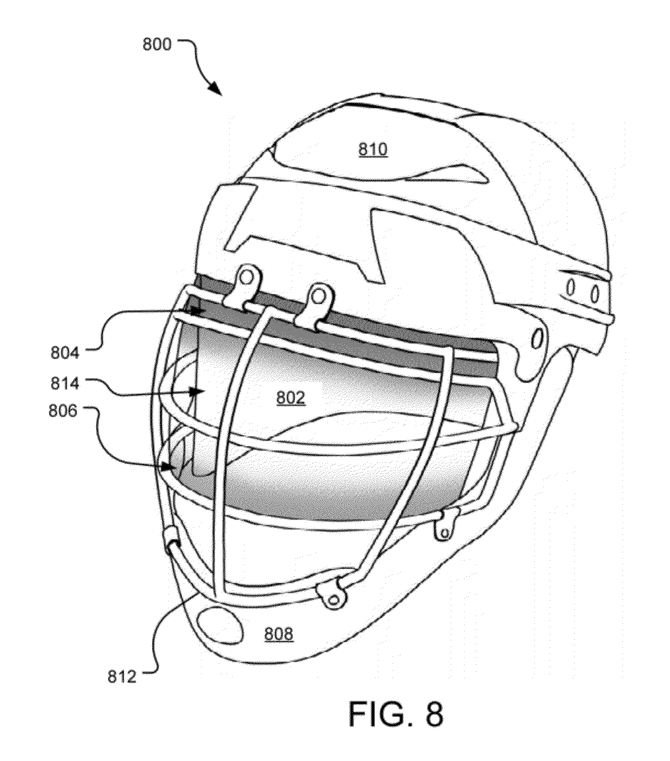

FIG. 8 is a perspective view of an example hockey goalie helmet 800 incorporating a gradient shield 802 having an upper gradient tinted region 804 and a lower gradient tinted region 806. The helmet 800 may be used to protect a user (not shown) from injury while goal-tending in a hockey game, or while participating in other activities. The helmet 800 incorporates a hard and/or soft shell section 810 that protects the user's skull and/or face from damage from potential impacts that may occur during use of the helmet 800. Further, the shell section 810 may be transparent, semi-transparent, or opaque. The helmet 800 further incorporates a face cage 812 and a chin guard 808 to protect the user's face from high-energy impacts. In other implementations, the helmet 800 does not include the face cage 812 and/or the chin guard 808.

The gradient shield 802 protects the user's face from impacts that may penetrate through the individual bars of the face cage 812. In implementations that do not include the face cage 812 and/or the chin guard 808, the gradient shield 802 provides most, if not all protection, of the user's face, particularly in the extra-sensitive area of the user's eyes. The gradient shield 802 is at least semi-transparent in a middle region 814 aligned with the user's eyes so that the user may see out of the helmet 800 and/or other individuals may see the user's face and/or eyes within the helmet 800.

The gradient regions 804, 806 vary in opacity from top to bottom. More specifically, the gradient shield 802 has a maximum opacity at the top and bottom of the gradient shield 802 that uniformly decreases within each of the gradient regions 804, 806 toward the middle of the gradient shield 802. The middle region 814 has a constant opacity. As a result, the amount of light transmitted through the gradient shield 802, specifically from the exterior of the gradient shield 802 to the interior of the gradient shield 802 and impinging on the user's face varies according to the positions of one or more exterior light sources (not shown) with respect to the location of the gradient shield 802 and the angle at which the light emanating from the light source(s) enters the gradient shield 802.

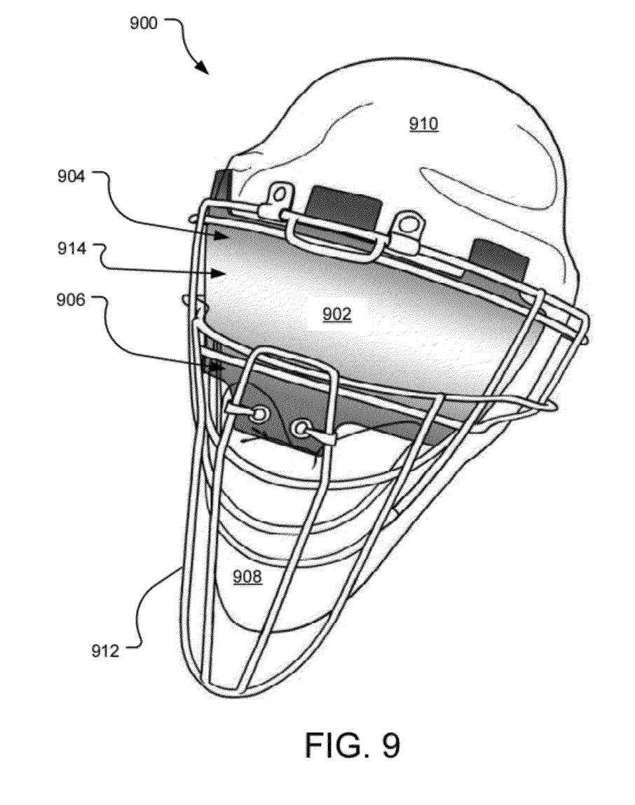

FIG. 9 is a perspective view of an example baseball catcher's helmet 900 incorporating a gradient shield 902 having an upper gradient tinted region 904 and a lower gradient tinted region 906. The helmet 900 may be used to protect a user (not shown) from injury while catching in a baseball game, or while participating in other activities. The helmet 900 incorporates a hard and/or soft shell section 910 that protects the user's skull and/or face from damage from potential impacts that may occur during use of the helmet 900. Further, the shell section 910 may be transparent, semi-transparent, or opaque. The helmet 900 further incorporates a face cage 912 and a chin guard 908 to protect the user's face from high-energy impacts. In other implementations, the helmet 900 does not include the face cage 912 and/or the chin guard 908.

The gradient shield 902 protects the user's face from impacts that may penetrate through the individual bars of the face cage 912. In implementations that do not include the face cage 912 and/or the chin guard 908, the gradient shield 902 provides most, if not all protection, of the user's face, particularly in the extra-sensitive area of the user's eyes. The gradient shield 902 is at least semi-transparent in a middle region 914 aligned with the user's eyes so that the user may see out of the helmet 900 and/or other individuals may see the user's face and/or eyes within the helmet 900.

The gradient regions 904, 906 vary in opacity from top to bottom. More specifically, the gradient shield 902 has a maximum opacity at the top and bottom of the gradient shield 902 that uniformly decreases within each of the gradient regions 904, 906 toward the middle of the gradient shield 902. The middle region 914 has a constant opacity. As a result, the amount of light transmitted through the gradient shield 902, specifically from the exterior of the gradient shield 902 to the interior of the gradient shield 902 and impinging on the user's face varies according to the positions of one or more exterior light sources (not shown) with respect to the location of the gradient shield 902 and the angle at which the light emanating from the light source(s) enters the gradient shield 902.

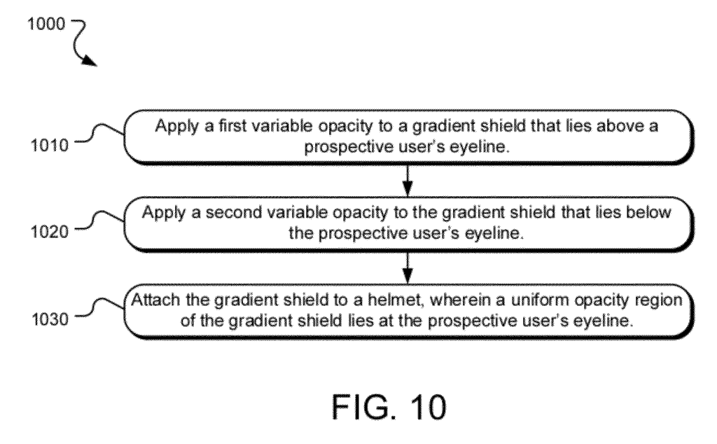

FIG. 10 illustrates operations 1000 for making a gradient shield according to the presently disclosed technology. An applying operation 1010 applies a first variable opacity to the gradient shield that lies above a prospective user's eyeline. The first variable opacity may vary in light transmittance with vertical distance from the user's eyeline, in some cases linearly or otherwise increasing with vertical distance from the user's eyeline. The applying operation 1010 may be performed at the time of manufacturing the gradient shield or the prospective user may perform the applying operation 1010. Further, the applying operation 1010 may be permanent or the first variable opacity may be removable from the gradient shield.

An applying operation 1020 applies a second variable opacity to the gradient shield that lies below the prospective user's eyeline. The first variable opacity may also vary in light transmittance with vertical distance from the user's eyeline, in some cases linearly or otherwise increasing with vertical distance from the user's eyeline. The applying operation 1012 may be performed at the time of manufacturing the gradient shield or the prospective user may perform the applying operation 1012. Further, the applying operation 1012 may be permanent or the first variable opacity may be removable from the gradient shield.

An attaching operation 1030 attaches the gradient shield to a helmet, wherein a uniform opacity region of the gradient shield lies at the prospective user's eyeline. For example, the gradient shield is attached to the helmet via one or more attachment points. The helmet may be specifically adapted for use in a variety of sports and other activities (see above). The uniform opacity region of the gradient shield is calculated to lie at the prospective user's eyeline based on the average configuration of a user's eye locations on the user's head and the size of the helmet itself. In other implementations, the locations of the uniform opacity region and the first and second variable opacities may be customized for a specific user.

The features of the helmets and the gradient shields discussed herein may be used in any combination and with any of the implementations of FIGS. 1-10. Further, the gradient shields discussed herein may also be implemented with various eyewear (e.g., goggles, eyeglasses, and sunglasses).

The embodiments of the invention described herein are implemented as logical operations that may be performed in any order and one or more operations may be omitted, unless explicitly claimed otherwise or a specific order is inherently necessitated by the claim language. The above specification, examples, and data provide a complete description of the structure and use of exemplary embodiments of the invention. Since many embodiments of the invention can be made without departing from the spirit and scope of the invention, the invention resides in the claims hereinafter appended. Furthermore, structural features of the different embodiments may be combined in yet another embodiment without departing from what the presently disclosed technology contemplates.

What is claimed is:

1. A gradient shield comprising:
a first gradient region, configured to lie below a user's eyeline, wherein the opacity of the first gradient region increases with vertical distance from the user's eyeline.

2. The gradient shield of claim 1, further comprising:
a second gradient region, configured to lie above the user's eyeline, wherein the opacity of the second gradient region increases with vertical distance from the user's eyeline.

3. The gradient shield of claim 1, further comprising:
a uniform opacity region, configured to lie at the user's eyeline.

4. The gradient shield of claim 3, wherein the uniform opacity region has a light transmittance of greater than 80%.

5. The gradient shield of claim 2, wherein the first and second gradient regions each have a light transmittance varying between 5% to 80%.

6. The gradient shield of claim 1, wherein the first gradient region includes a removable decal applied to a surface of the gradient shield.

7. The gradient shield of claim 1, wherein the first gradient region includes a visual graphic.

8. A method comprising:
applying a first variable opacity to a gradient shield, wherein the first variable opacity is configured to lie below a user's eyeline and increases with vertical distance from the user's eyeline.

9. The method of claim 8, further comprising:
applying a second variable opacity to the gradient shield, wherein the second variable opacity is configured to lie above the user's eyeline and increases with vertical distance from the user's eyeline.

10. The method of claim 8, wherein the gradient shield includes a uniform opacity region configured to lie at the user's eyeline.

11. The method of claim 8, wherein the applying operation includes placing a removable decal on a surface of the gradient shield.

12. A helmet comprising:
a shell configured to encompass a portion of a user's head; and
a gradient shield configured to lie in front of the user's face, wherein the gradient shield includes a first gradient region, configured to lie below the user's eyeline, wherein the opacity of the first gradient region increases with vertical distance from the user's eyeline.

13. The helmet of claim 12, wherein the gradient shield further includes a second gradient region, configured to lie above the user's eyeline, wherein the opacity of the second gradient region increases with vertical distance from the user's eyeline.

14. The helmet of claim 12, wherein the gradient shield further includes a uniform opacity region, configured to lie at the user's eyeline.

15. The helmet of claim 12, wherein the gradient shield is attached to the shell.

16. The helmet of claim 12, further comprising:
a face cage attached to the shell, wherein the gradient shield is attached to the face cage.

17. The helmet of claim 12, wherein the first gradient region includes a removable decal applied to a surface of the gradient shield.

18. The helmet of claim 12, wherein the first gradient region includes a visual graphic.

19. The helmet of claim 12, wherein the gradient shield is one continuous piece attached to the shell at two or more attachments points.

20. A gradient shield comprising:
a removable gradient region, configured to lie above a user's eyeline, wherein the opacity of the first gradient region increases with vertical distance from the user's eyeline.
